(19) United States
(12) Patent Application Publication
(10) Pub. No.: US 2017/0124516 A1
(43) Pub. Date: May 4, 2017

(54) PRESENTING MATCHES OF LOAN OFFICER INFORMATION AND LOAN SERVICE PROVIDERS ON A GRAPHICAL USER INTERFACE

(71) Applicant: Modex, inc., Spokane, WA (US)

(72) Inventors: Dale Larson, JR., Everett, WA (US); Dale Larson, III, Everett, WA (US); Edan Shahar, Seattle, WA (US); Brett Turner, Encinitas, CA (US); Jeff Judy, Snohomish, WA (US)

(21) Appl. No.: 15/339,785

(22) Filed: Oct. 31, 2016

Related U.S. Application Data
(60) Provisional application No. 62/249,181, filed on Oct. 30, 2015.

(51) Int. Cl. G06Q 10/10

(52) U.S. Cl. CPC G06Q 10/1053; G06Q 40/025

(57) ABSTRACT

A platform for gathering information about loan officers and loan service providers from a disparate array of sources. The platform can generate graphical user interfaces that facilitate entry and presentation of information associated with the loan officers and the loan service providers. The graphical user interface provided by the platform can be configured to facilitate the manipulation of information to provide an indication of a value of a loan officer to a loan service provider.

### CROSS-REFERENCE TO RELATED APPLICATIONS

This application claims priority to and the benefit of U.S. Provisional Patent Application No. 62/249,181, titled “Platform for Optimizing and Transmitting Loan Officer Information,” filed on Oct. 30, 2015, the disclosure of which is incorporated herein in its entirety.

### FIELD OF THE INVENTION

The presently described technology relates to a platform for optimizing and transmitting loan office information.

### BACKGROUND

While technology has driven process automation in the mortgage lending industry, business is fueled by strong client relationships. As a result, the entire food chain is largely controlled by the loan officers and the loans they produce.

### SUMMARY

A platform is provided for normalizing custom recruiting methods and compensation packages of loan service providers and loan officers.

In some aspect, in accordance with a system, method and computer program product, an executable computer-implemented process includes mining loan information from a plurality of loan information sources, the loan information comprising data associated with a loan officer, and identifying loan transactions involving individual ones of the loan officers. The process further includes calculating a loan officer metric for individual ones of the loan officers, the loan officer metric being based on the identified loan transactions involving the loan officer and including an indication of the services the loan officer performs. The process further includes comparing the loan officer metric with a loan service provider metric for a loan service provider, and generating, on a display, a graphical user interface presenting the comparison between the loan officer metric and the loan service provider metric, the comparison providing an indication of the loan officer's compatibility with the loan service provider.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 shows a diagram of a system that can implement one or more features consistent with the current subject matter;

FIG. 2 shows a diagram of a graphical user interface having one or more features consistent with the current subject matter;

FIG. 3 shows a diagram of a graphical user interface having one or more features consistent with the current subject matter; and,

FIG. 4 is a process flow diagram illustrating a method having one or more features consistent with the presently described subject matter.

### DETAILED DESCRIPTION

Loan service providers, such as underwriters, lenders and brokers, covet loan volume. Loan volume drives revenue and profit for the lending industry. Loan officers, having the business relationships, tend to be the individuals driving the lending volume. Consequently, loan officers are in high demand by underwriters, lenders and broking agencies.

A loan service provider can be an organization that collects interest, principal and escrow payments from a borrower of a loan. Most mortgages are backed by the government or government-sponsored entities, through the purchase of loans by the government or government-sponsored entities. Most of these loan purchasers do not service the loans, and therefore, a loan service provider can service the loans, collecting interest, principle and escrow payments on loans held by other organizations. A loan service provider will typically remit these funds to various entities, including payment of principle and interest to the note holder of the loan, payment of taxes and insurance from escrowed funds and fees to mortgage guarantors and the like. In exchange for these services, the loan service provider generally receives contractually specified loan servicing fees and other ancillary sources of income, for example, float or late charges. Consequently, the greater the volume of loans, the more fees generated by loan service providers.

The lending industry, and especially the mortgage industry, is a highly fragmented industry. Different banks and brokerage agencies offer different services and products, requiring different expertise of their employees. For example, the different services that may be offered include processing, underwriting, lending, and servicing of loans. The ways the different actors generate fees from loan volume varies. Consequently, the loan service providers require employees that have specific skill sets that mesh well with the services they offer. This leads to custom recruiting methods and compensation packages.

These custom recruiting methods and compensation packages need to be normalized. Without being able to normalize these recruiting methods and compensation packages, the hiring process gets bogged down with heavy resistance caused by a number of challenges.

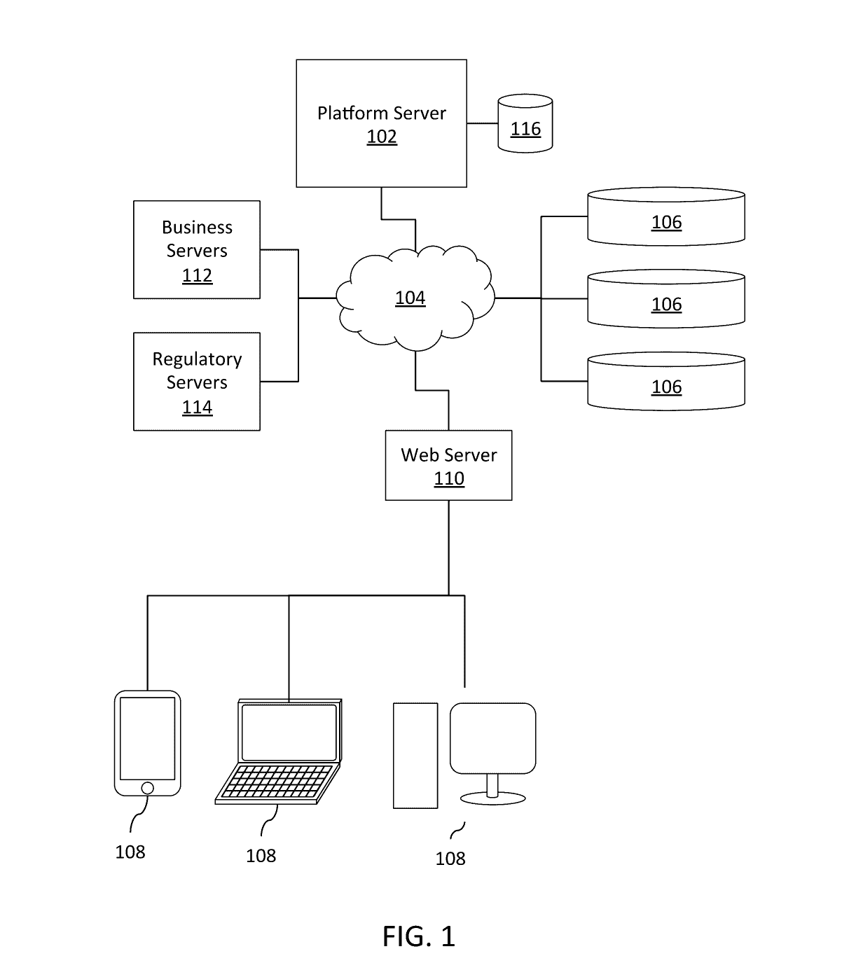

FIG. 1 is an illustration of a system 100 having one or more elements consistent with the current subject matter. The system 100 can comprise a platform server 102. The platform server 102 can be configured to support a computer software product configured to cause the platform server 102 to perform one or more operations that are consistent with the current subject matter. The platform server 102 may be in electronic communication with one or more networks, such as the Internet 104. The platform server 102 may be configured to mine loan transaction data from one or more databases 106. The database(s) 106 can be accessed through a network, such as the Internet 104. The database(s) 106 may be provided in portable memory and introduced to the platform server 102 through one or more physical electronic connection ports at the location of the platform server 102. The database(s) may be maintained by commercial organizations, governmental or quasi-governmental entities, title or escrow companies, mortgage industry organizations, banks, mortgage companies, stock market reports, research entities, or other entities, both public and private, or the like.

The information mined by the platform server 102 may include data on mortgage loan officers (MLOs) and loan issuances in connection with purchased property, and any other mortgage industry related data or metrics. In some variations, the data may be found through major search engines, digital lists, directories, libraries, magazines, trade journals, or any other media both digital and in print.

The information gathered on the MLOs may include the type of services offered, the quantity of loans, the monetary value of the loans, the rate of loan generation, the ratio of loans generated vs. the loans closed, the types of creditors involved, the types of lenders involved, or the like.

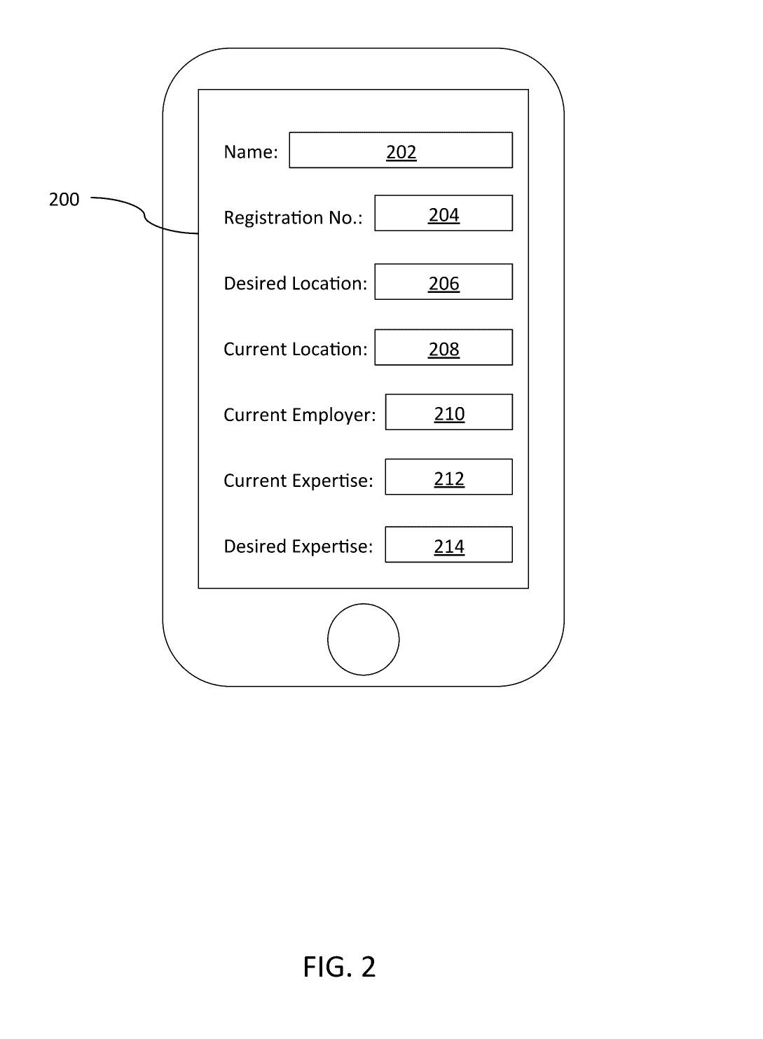

The platform server 102 can be configured to communicate with one or more user devices 108. The one or more user devices 108 can be configured to communicate with the one or more platform servers 102 through a network, such as the Internet 102. In some variations, the client device(s) 108 may communicate with the platform server 102 through one or more web servers 110. The user device(s) 108 may be associated with an MLO. The user device(s) 108 may be configured to present a graphical user interface to the MLO. FIG. 2 is an illustration of a conceptual graphical user interface 200 having one or more elements consistent with the present description.

The graphical user interface 200 can be configured to facilitate entry and/or selection of one or more information elements by the MLO. For example, the one or more information elements can include a name 202, a registration number 204, a desired location 206, a current location 208, a current employer 210, a current expertise set 212, a desired expertise 214, a current income, a current amount of loans, a current value of loans, or the like. While the graphical user interface 200 is illustrated in connection with a smartphone the presently described subject matter contemplates a graphical user interface 200 provided through a laptop, desktop, tablet, or the like.

The information provided by the MLO through the graphical user interface 200 can be transmitted to the platform server 102.

The platform server 102 can be configured to communicate with one or more business servers 112. The one or more business servers 112 can be associated with one or more loan service providers. As discussed above, the one or more business servers 112 can be configured to provide loan service provider information to the platform server 102. The loan service provider information can comprise type of service provided, amount of services provides, amount of loans handled, monetary value of loans handled, number of loans in default, or the like.

The platform server 102 can be configured to communicate with one or more regulatory servers 114. The one or more regulatory servers 114 can be configured to provide information associated with the qualifications of the MLO and/or the loan service providers, or the like. The one or more regulatory servers 114 can provide information associated with compliance or non-compliance with regulations or industry customs by the MLO and/or loan service provider to the platform server 102.

The platform server 102 can be configured to store the gathered information in a data store 116 connected with the platform server 102.

The platform server 102 can be configured to use the gathered information and generate a repository, or collection of repositories, that form the basis of data driven platform. The data can be gathered in a fully automated manner. The data can be gathered using one or more users to gather the data manually. Data can be obtained from users or prospective users of the platform. The users or prospective users can include mortgage loan officers, banks, and mortgage bankers, mortgage brokers. In some variations, the platform server 102 can be configured to continually gather data from the one or more data sources.

The platform server 102 can comprise one or more data processors configured to perform one or more operations. The one or more operations can be performed on the gathered data. For example, the one or more operations can be performed on the gathered data 116. The platform server 102 can be configured to use neural networks, machine learning algorithms, or the like to process the gathered data.

The platform server 102 can be configured to correlate the Nationwide Mortgage Licensing System (NMLS) Unique Identifier of MLOs, with data associated with the loan itself, such as the loan amount, bank, mortgage banker, or mortgage broker, company or branch location, underlying property location, closing date, and other information.

Detailed profiles of MLOs can be generated by the platform server 102. The MLO profiles can include information associated with the MLOs. For example, the information included in an MLO profile can include history of loans closed. The information can then be verified and past performance evaluated.

The platform server 102 can be configured to apply one or more performance review criteria. The platform server 102 can be configured to apply one or more ranking criteria. The platform server 102 can be configured to assign a “score” to each MLO in response to the application of the performance review criteria and/or the ranking criteria. The platform server 102 can score an MLO by application of a scoring metric to the data associated with the MLO.

A scoring metric can be generated for the MLO based on the data types and data-type quantities gathered by the platform server 102. In response to gathering additional information, the additional information can be evaluated by the platform server 102. The platform server 102 can modify the scoring metric based on the type and quantity of the additional information gathered by the platform server.

An MLO metric comprising one or more MLO vectors can be generated for each MLO on which the platform server 102 has gathered information. A confidence factor on that information can be generated based on a veracity score of the information, an amount of the information, a type of the information, or the like.

Similarly, a loan service provider metric comprising one or more loan service provider vectors can be generated for each loan service provider on which the platform server 102 has gathered information. A confidence factor on that information can be generated based on a veracity score of the information, an amount of the information, a type of the information, or the like.

Detailed profiles of loan service providers can be generated by the platform server 102. The loan service provider profiles can include information associated with the loan service providers. For example, the information included in a loan service provider profile can include a performance of a loan service provider with respect to one or more key evaluation criteria associated with loans. Some examples of key evaluation criteria can include: an indication of the type of lenders associated with the loans serviced by the loan service provider; a customer rating of the loan service provider; a percentage of lenders in default; an employee satisfaction measure associated with then loan service provider; or the like. In some variations, the information in the loan service provider profile can then be verified and past performance can be evaluated.

The platform server 102 can be configured to apply one or more performance review criteria to a loan service provider. The platform server 102 can be configured to apply one or more ranking criteria to a loan service provider. The platform server 102 can be configured to assign a “score” to each loan service provider in response to the application of the performance review criteria and/or the ranking criteria for the loan service provider. The platform server 102 can score the loan service provider by application of a scoring metric to the data associated with the loan service provider.

A scoring metric can be generated for the loan service provider based on the data types and data-type quantities gathered by the platform server 102. In response to gathering additional information, the additional information can be evaluated by the platform server 102. The platform server 102 can modify the scoring metric based on the type and quantity of the additional information gathered by the platform server about the loan service provider.

A loan service provider metric comprising one or more loan service provider vectors can be generated for each loan service provider on which the platform server 102 has gathered information. A confidence factor on that information can be generated based on a veracity score of the information, an amount of the information, a type of the information, or the like.

The platform server 102 can be configured to facilitate comparing the MLO metrics with the loan service provider metrics to determine matches between MLOs and loan service providers. Matches can be exact matches. Matches can include MLO metrics and loan service provider metrics that have one or more vectors within one or more ranges of desired targets. In some variations, an MLO can initiate the process of finding loan service providers having a loan service provider metric that matches with the MLO metric. A loan service provider metric can include a plurality of different loan service provider values. Each loan service provider value of the loan service provider metric can relate to a different factor associated with the performance of the loan service provider. Similarly, an MLO metric can include a plurality of different MLO values. Each MLO value of the MLO metric can relate to a different factor associated with the performance of the MLO.

Matching the loan service provider metric to the MLO metric can include analyzing one or more of the loan service provider values and one or more corresponding MLO values to determine compatibility between the MLO and the loan service provider. For example, a loan service provider can be focused on foreclosing on properties. The metric for that loan service provider can include one or more loan service provider values indicative that the loan service provider is focused on foreclosing on properties. MLOs matched with such a loan service provider may have an MLO metric having one or more MLO values indicative of the MLO being experienced and successful in foreclosing on properties.

A loan service provider might have a plurality of specialties. MLOs matched with such a loan service provider may cater to one or multiple ones of those specialties.

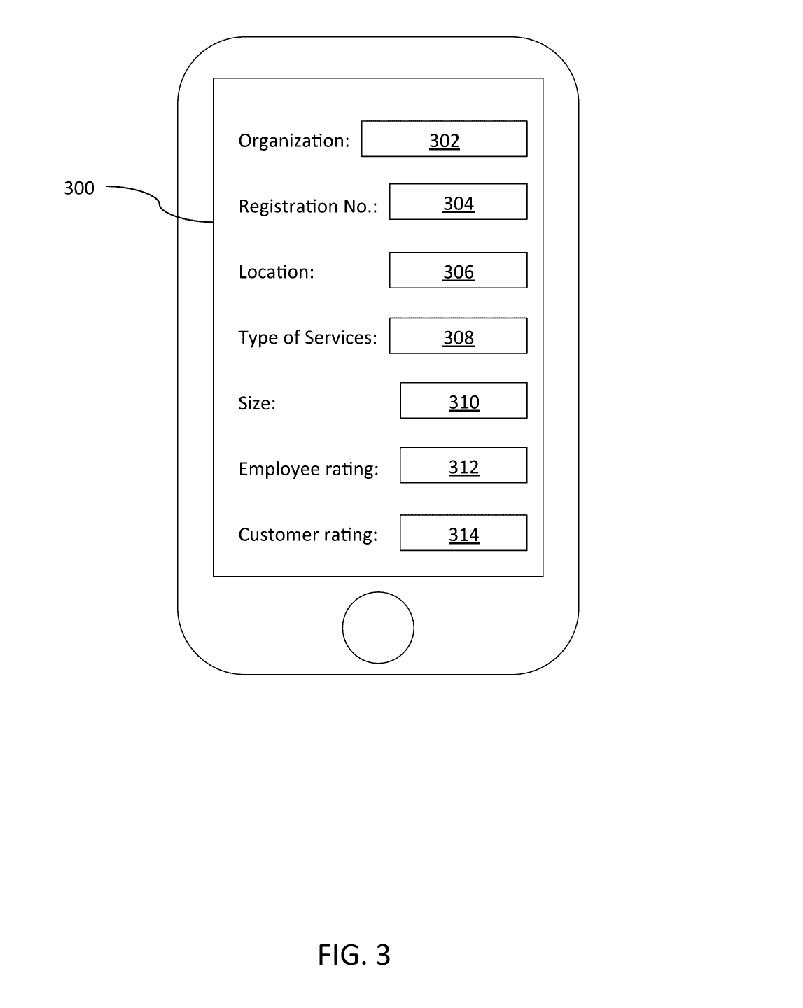

The platform server 102 can be configured to perform a Match Maker System (MMS). A graphical representation of the results of the MMS can be generated and presented to an MLO on a display of a user device 106 associated with the MLO. FIG. 3 is an illustration of a graphical user interface 300 having one or more elements consistent with the present description. The graphical user interface 300 can include information on the loan service providers matching the metrics of the MLO. Loan service providers presented can include banks, mortgage bankers, mortgage brokers, or the like, that meet the MLO's metrics. The graphical user interface 300 can present information about the loan service providers including the name of the organization 302, its registration number 304, its location 308, the type of services offered 308, the size 310, an employee rating 312, a customer rating 314, photographs of the offices, organization projections, industry expert analysis, estimated compensation, benefits, reviews, or the like.

Similarly, a loan service provider can be presented, on a display, with a graphical user interface that includes information about prospective MLOs that meet its metrics. Prospective MLOs can be determined by the MMS.

The platform server 102 can provide applications configured to integrate into the loan service providers recruitment applications. Prospective candidates can be presented to the loan service provider. Information associated with the MLO can be presented to the loan service provider. An interview schedule can be generated based on parameters provided by the MLO and/or the loan service provider. A detailed diligence report on the MLO can be provided to loan service providers.

The platform server 102 can be configured to provide verification of the MLO's stated performance. The platform server 102 can be configured to generate a report on the value provided by a newly hired MLO at the loan service provider.

Profiles for MLOs and/or loan service providers may include one or more useable settable privacy settings. Some of the privacy settings can be complex privacy settings. MLOs and/or loan service providers can be assigned one or more privileges. The privilege(s) can grant access to certain levels of information by MLOs or loan service providers

For example, an existing employer of an MLO may be granted permission to see a basic public-facing profile of the MLO. The basic public-facing profile of the MLO may look the same to anyone accessing the platform. The basic public-facing profile of the MLO may have the same appearance whether the MLO is looking for new opportunities or not. Other potential employers of the MLO may be granted permission to see a more detailed profile of the MLO. The more detailed profile of the MLO may provide information about the MLO that would be valuable for decision making by a loan service provider, such as the information presented in FIG. 3 and discussed in relation to FIG. 3.

The graphical user interface presented to an MLO can be configured to facilitate entry and/or selection of one or more pieces of information. For example, the information can include whether or not the MLO is considering a change of employment, whether they are available for interviews, the type of employment they desire, and the like.

The platform server 102 can be configured to determine a value of the MLO. The platform server 102 can use gathered information, either from data sources, or directly from the MLO, and compare the MLO information to the market to determine an appropriate compensation package. The compensation package can be configured to depend on different scenarios. A graphical user interface presented to the MLO through computing devices 106 can be configured to facilitate modification of scenario information to determine the MLO's compensation package under scenarios matching that information.

The platform server 102 can be configured to facilitate selection of, through a user interface, of an MLO and/or loan service provider by prospective borrowers. For example, the loan service provider metric and/or the MLO metric can be used to generate a consumer score for the MLO and/or loan service provider. The consumer score for the MLO and/or loan service provider can include an indication that the MLO and/or loan service provider is relatively good for consumers compared to other MLO and/or loan service providers.

The platform server 102 can be configured to facilitate advertisement by loan service providers of positions for MLOs. The platform server 102 can be configured to generate a graphical user interface no a display device that configured to facilitate filtering of the loan service providers by their loan service provider score. In some variations, when MLOs apply to loan service providers, the loan service providers can filter applicants by their MLO score. The MLO metric can include one or more MLO values that facilitate determination of one or more competencies of the MLO. The platform server 102 can be configured to facilitate targeted advertising by a loan service provider to MLOs having MLO metrics that match certain desired criteria.

Similarly, the platform server 102 can be configured to facilitate targeted advertising to third parties using the MLO metrics and/or the loan service provider metrics.

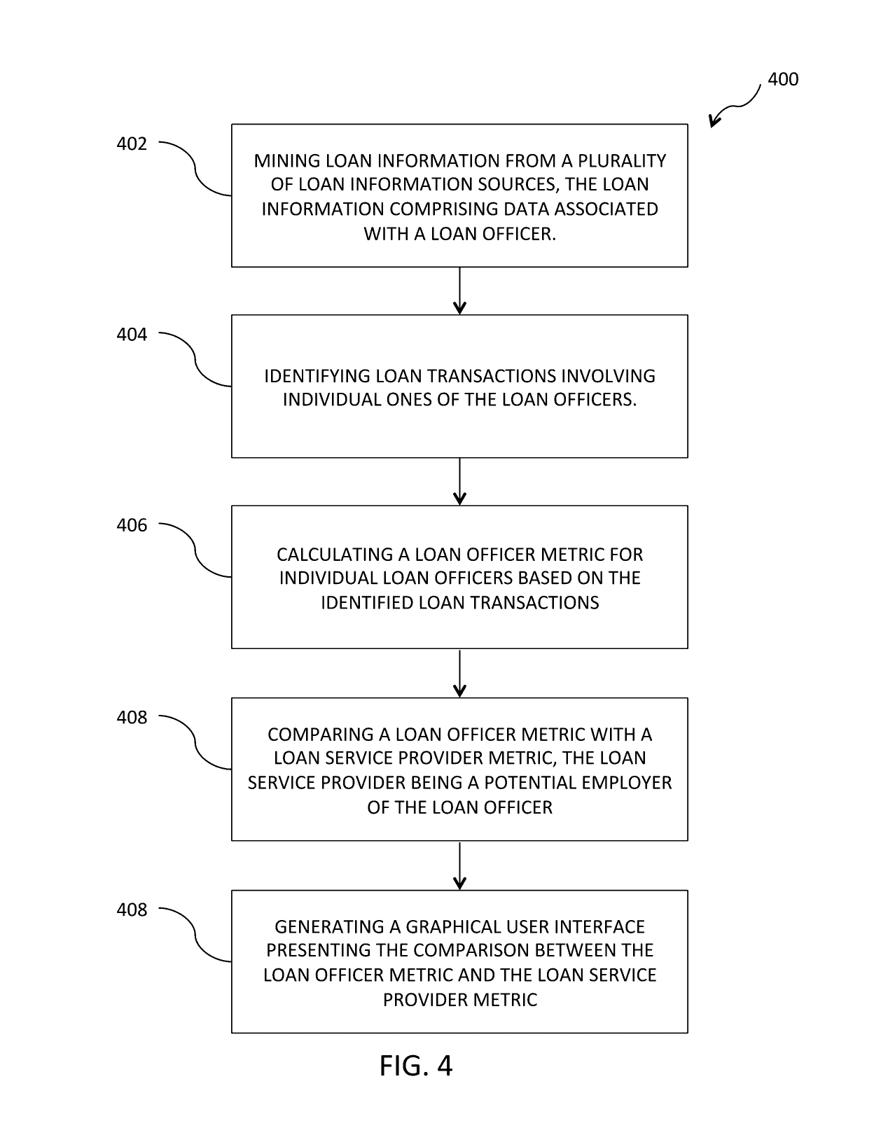

FIG. 4 is a process flow diagram of a method 400 having one or more features consistent with the current subject matter. The operations of method 400 can be performed by a computer system, such as platform server 102 illustrated in FIG. 1.

At 402, loan information can be mined. In some implementations, the loan information is mined by the computer system from a plurality of loan information sources. The loan information can comprise data associated with a loan officer.

At 404, loan transactions can be identified that involve individual loan officers. In preferred exemplary implementations, the identification is executed by computer system. At 406, a loan officer metric can be calculated for individual loan officers. The loan officer metric can be based on the identified loan transactions involving the loan officer. At 408, the loan officer metric can be compared with a loan service provider metric for a loan service provider. The loan service provider can be an employer or a potential employer of the loan officer.

At 410, a graphical user interface can be generated. The graphical user interface can be configured to present the comparison between the loan officer metric and the loan service provider metric. The comparison can provide an indication of the loan officer's compatibility with the loan service provider.

Without in any way limiting the scope, interpretation, or application of the claims appearing herein, a technical effect of one or more of the example embodiments disclosed herein may include generating complex and dynamic MLO and loan service provider metrics to find MLO metrics that match with service provider metrics. Information associated with the loan industry can be presented through client devices.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other. The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A method to be performed on one or more data processors comprising at least part of a computer system, the method comprising:
mining, using the one or more data processors, loan information from a plurality of loan information sources, the loan information comprising data associated with a loan officer;
identifying loan transactions involving individual ones of the loan officers;
calculating, using the one or more data processors, a loan officer metric for individual ones of the loan officers, the loan officer metric being based on the identified loan transactions involving the loan officer and including an indication of the services the loan officer performs;
comparing, using the one or more data processors, the loan officer metric with a loan service provider metric for a loan service provider; and
generating, on a display, a graphical user interface presenting the comparison between the loan officer metric and the loan service provider metric, the comparison providing an indication of the loan officer's compatibility with the loan service provider.

2. The method in accordance with claim 1, wherein the loan service provider is a potential employer of the loan officer.

3. The method in accordance with claim 1, wherein each loan officer metric includes one or more mortgage loan officer (MLO) vectors representing a confidence factor on information from the loan information.

4. The method in accordance with claim 1, wherein the loan service metric includes one or more loan service provider vectors representing a confidence factor on information associated with the loan service provider.

5. A non-transitory computer program product storing instructions that, when executed by at least one programmable processor, cause the at least one programmable processor to perform operations comprising:
mining loan information from a plurality of loan information sources, the loan information comprising data associated with a loan officer;
identifying loan transactions involving individual ones of the loan officers;
calculating a loan officer metric for individual ones of the loan officers, the loan officer metric being based on the identified loan transactions involving the loan officer and including an indication of the services the loan officer performs;
comparing the loan officer metric with a loan service provider metric for a loan service provider; and
generating, on a display, a graphical user interface presenting the comparison between the loan officer metric and the loan service provider metric, the comparison providing an indication of the loan officer's compatibility with the loan service provider.

6. The computer program product in accordance with claim 5, wherein the loan service provider is a potential employer of the loan officer.

7. The computer program product in accordance with claim 5, wherein each loan officer metric includes one or more mortgage loan officer (MLO) vectors representing a confidence factor on information from the loan information.

8. The computer program product in accordance with claim 5, wherein the loan service provider metric includes one or more loan service provider vectors representing a confidence factor on information associated with the loan service provider.

9. A system comprising:
at least one programmable processor; and
a machine-readable medium storing instructions that, when executed by the at least one processor, cause the at least one programmable processor to perform operations comprising:
mine loan information from a plurality of loan information sources, the loan information comprising data associated with a loan officer;
identify loan transactions involving individual ones of the loan officers;
calculate a loan officer metric for individual ones of the loan officers, the loan officer metric being based on the identified loan transactions involving the loan officer and including an indication of the services the loan officer performs;
compare the loan officer metric with a loan service provider metric for a loan service provider; and
generate, on a display, a graphical user interface presenting the comparison between the loan officer metric and the loan service provider metric, the comparison providing an indication of the loan officer's compatibility with the loan service provider.

10. The system in accordance with claim 9, wherein the loan service provider is a potential employer of the loan officer.

11. The system in accordance with claim 9, wherein each loan officer metric includes one or more mortgage loan officer (MLO) vectors representing a confidence factor on information from the loan information.

12. The system in accordance with claim 9, wherein the loan service metric includes one or more loan service provider vectors representing a confidence factor on information associated with the loan service provider.
